(19) United States
(12) Patent Application Publication
(10) Pub. No.: US 2024/0392619 A1
(43) Pub. Date: Nov. 28, 2024

(54) Shock Absorber Device for Protecting a Door and Door Frame

(71) Applicant: Elvis Torrealba, Orlando, FL (US)

(72) Inventor: Elvis Torrealba, Orlando, FL (US)

(21) Appl. No.: 18/507,703

(22) Filed: Nov. 13, 2023

Related U.S. Application Data
(60) Provisional application No. 63/504,322, filed on May 25, 2023.

(51) Int. Cl. E05F 5/04

(52) U.S. Cl. CPC E05F 5/04; E05F 2005/046

(57) ABSTRACT

A door protector shock absorbing device including two integrated components featuring a fixed component made of generally rectilinear metal sheet having a one or more grooves disposed therein, the fixed component is fastened to a door frame using one or more screw fasteners fastened transversely through the grooves. A movable component is connected to the fixed component using a hinge along an edge of the fixed component, the movable component has an elastomeric member. The movable component is designed to move more than 180-degrees relative to the fixed component such that the elastomeric member is positioned along a corner of the door frame wherein the door strikes the elastomeric member/device when slammed shut, thereby the elastomeric member/device prevents direct contact of the door and the door frame. The movable component is moved towards the fixed component when the device is not operational.

### CROSS-REFERENCE TO RELATED APPLICATION

The present application claims priority to, and the benefit of, U.S. Provisional Application No. 63/504,322, which was filed on May 25, 2023, and is incorporated herein by reference in its entirety.

### FIELD OF THE INVENTION

The present invention generally relates to the field of door protector devices. More specifically, the present invention relates to a novel shock absorbing device designed to be installed on a door frame and for absorbing shock from a door when the door is forcefully slammed. Elastomeric device is positioned along a corner edge of the door frame such that the door strikes the rubber device which cushions the blow of the door. The device is installed using a fixed component using fasteners and the elastomeric device is disposed on a movable component which is hingedly coupled to the fixed component. Accordingly, the present disclosure makes specific reference thereto. Nonetheless, it is to be appreciated that aspects of the present invention are also equally applicable to other like applications, devices, and methods of manufacture.

### BACKGROUND

By way of background, it is common for windows to be left open to facilitate ventilation and airflow during construction or remodeling of buildings such as homes, offices, hotels, and other structures. However, this may lead to doors slamming shut due to the wind passing through the building. Commonly, doors during construction and remodeling do not have an automatic closing mechanism, thus close abruptly and forcefully, potentially causing damage to the door, frame, and locking mechanism. Similar things are observed in high rise buildings where individuals inadvertently leave doors open which can then be slammed shut forcefully due to blowing wind.

Commonly, to prevent doors from closing, some individuals resort to applying the lock bolt, which is the part of the lock that extends into the door frame when the door is locked. However, if the door is still shut quickly by wind or manual force, the door can exert a considerable impact on the lock and door, leading to potential damage. When a door slams against the deadbolt, the force can be transmitted to the door frame and the lock itself. This repeated impact can weaken and eventually break the door frame, causing structural issues with the door and compromising its functionality. In residential settings, such as homes, this issue becomes even more concerning because it can pose a safety risk, especially for children. Builders, contractors, and homeowners desire a device that can prevent damage to doors, door frames and locks while preventing individuals from injuries.

Therefore, there exists a long felt need in the art for a damage prevention accessory for doors capable of protecting a door, a door frame, and its lock from a strike. There is also a long felt need in the art for a shock absorber device for absorbing shock from a door when the door is quickly and forcefully closed. Additionally, there is a long felt need in the art for a novel device that prevents a door from slamming a door frame when closed or slammed shut abruptly and forcefully. Moreover, there is a long felt need in the art for a shock absorbing device that creates a space between a door and a door frame when the door is abruptly and forcefully shut. Further, there is a long felt need in the art of a damage prevention accessory for doors that reduces the chance of extensive damage occurring to the door, the door frame, and its lock if a door is shut quickly due to wind or manual application. Finally, there is a long felt need in the art for a door protection device that prevents incurring additional expenses for door or door frame repairs/damage and replacements of same.

The subject matter disclosed and claimed herein, in one embodiment thereof, comprises a shock absorber door protector device designed to protect a door, a door frame, and the associated dead bolt lock from damage upon sudden and hard closing of the door. The device is designed to be installed on a door frame and includes a pair of integrated parts, the integrated parts include a first component designed to be fixed to the door frame using mechanical fasteners, a movable component joined to the first component by a hinge along a longitudinal length of the first component and which is designed to be moved more than 180-degrees, the movable component includes an elastomeric device that functions as a shock absorber. The device protects the door from making contact with the door frame and the movable component aligns with the sides of the door frame, exposing the elastomeric device to the door such that the door strikes the elastomeric device when closed suddenly.

In this manner, the shock absorber door protector device of the present invention accomplishes all of the forgoing objectives and provides users with a damage prevention accessory for doors capable of protecting the door, the door frame, and the associated lock from damage due to a hard strike of the door. The shock absorbing elastomeric member/device prevents a door from slamming shut against a dead bolt lock and the door frame. The device can be easily installed and can be positioned to absorb shock from the door.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a shock absorber device for protecting a door, a door frame, and the associated dead bolt lock from damage upon sudden and hard closing of the door. The shock absorber device further comprising a fixed component configured to be fastened on a door frame, a movable component movably coupled along a longitudinal edge of the fixed component. The movable component includes two transversely joined metal sheets or arms and an elastomeric rubber is attached to the movable component. The fixed component has a pair of parallel grooves along the length thereof, each groove is designed for transversely receiving at least one screw fastener such that the screw fasteners used with the grooves are inserted into the door frame for securing the shock absorber device. The movable component is moved along a hinge positioned on the longitudinal edge of the fixed component for exposing the elastomeric rubber to the door, such that when the door is closed, the door strikes the elastomeric rubber which absorbs the shock and prevents direct contact of the door and the door frame.

In yet another embodiment, a door protector device configured to protect a door, a door frame, and the associated dead bolt lock from damage due to sudden and hard closing of the door. The device includes a pair of integrated parts, the integrated parts include a first component designed to be fixed to the door frame using mechanical fasteners, a movable component joined to the first component by a hinge along a longitudinal length of the first component and which is designed to be moved more than 180-degrees, the movable component includes an elastomeric device that functions as a shock absorber. The device in an operation state protects the door from making contact with the door frame and the movable component aligns with the sides of the door frame, exposing the elastomeric device to the door such that the door strikes the elastomeric device when closed suddenly.

In yet another embodiment, in a non-operational state of the device, the movable part does not make contact with the door frame and adheres to the fixed member, thereby removing the elastomeric device from between the door and the door frame.

Advantages of the device of the present invention is that it reduces the chance of extensive damage occurring to the door, the door frame, and its lock if a door is shut quickly due to wind or manual application. Further, the device is easy to install and can be easily positioned in an operational state to adhere to sides of a door frame.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the door protector device of the present invention in accordance with the disclosed structure;

FIG. 2 illustrates an enlarged view of the door protection device of the present invention fastened to a door frame and oriented for protecting the door, the door frame, and door lock from damage in accordance with the disclosed structure;

FIG. 3 illustrates a side perspective view showing the first member of the door protection device of the present invention fastened into the door frame in accordance with the disclosed structure;

FIG. 4 illustrates a perspective view showing the door protection device installed in the door frame and oriented in a non-operational state in accordance with the disclosed structure; and

FIG. 5 illustrates the shock absorber device of the present invention protecting the door while the door is being closed in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a damage prevention accessory for doors capable of protecting a door, a door frame, and its lock from a strike or door slam. There is also a long felt need in the art for a shock absorber device for absorbing shock from a door when the door is quickly and forcefully closed. Additionally, there is a long felt need in the art for a novel device that prevents a door from slamming a door frame when closed, slammed, or shut abruptly and forcefully. Moreover, there is a long felt need in the art for a shock absorbing device that creates a space between a door and door frame when the door is abruptly and forcefully shut. Further, there is a long felt need in the art of a damage prevention accessory for doors that reduces the chance of extensive damage occurring to the door, the door frame, and the door lock if a door is shut quickly due to wind or manual application. Finally, there is a long felt need in the art for a door protection device that prevents incurring additional expenses for door or frame repairs and damaged replacements of same.

The present invention, in one exemplary embodiment, is a shock absorber device for protecting a door, a door frame, and an associated dead bolt lock from damage due to hard slamming of the door. The shock absorber device further comprising a fixed component configured to be fastened on a door frame, a movable component movably coupled along a longitudinal edge of the fixed component. The movable component includes two transversely joined metal sheets or arms and an elastomeric rubber is attached to the movable component. The fixed component has a pair of parallel grooves along the length thereof, each groove is designed for transversely receiving at least one screw fastener such that the screw fasteners used with the grooves are inserted into the door frame for securing the shock absorber device. The movable component is moved along a hinge positioned on the longitudinal edge of the fixed component for exposing the elastomeric rubber to the door, such that when the door is closed, the door strikes the elastomeric rubber which absorbs the shock and prevents direct contact of the door and the door frame.

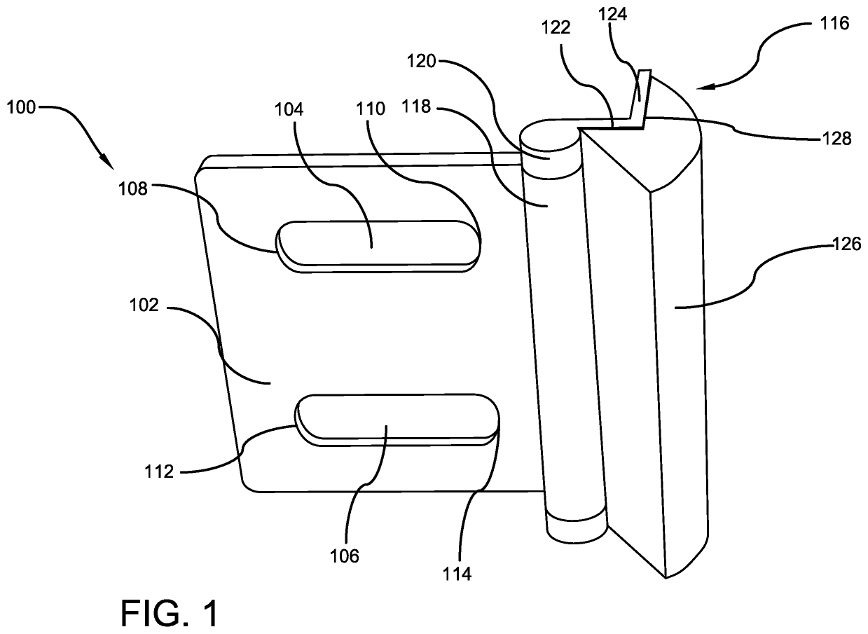

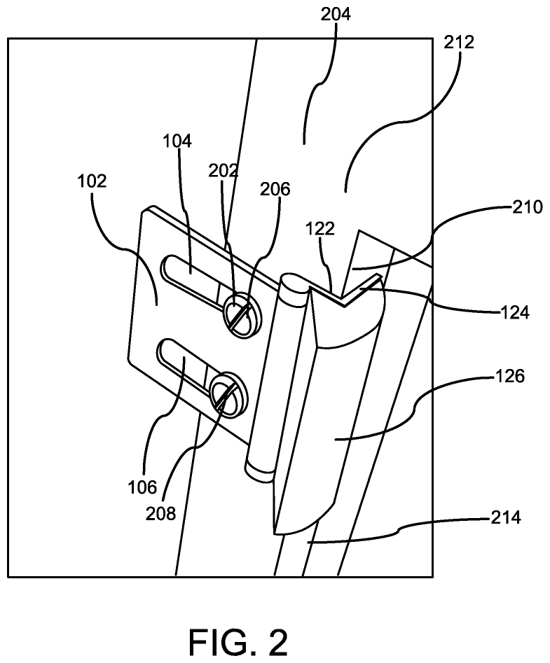

Referring initially to the drawings, FIG. 1 illustrates a perspective view of the door protector device of the present invention in accordance with the disclosed structure. The door protector device 100 of the present invention is designed to protect a door, a door frame and an associated door lock from damage when the door strikes or closes quickly and harshly due to wind or manual force by a user. More specifically, the door damage prevention accessory device 100 includes a generally square or rectangular (i.e., rectilinear) first member 102 which is designed to be installed on a door frame using a pair of fasteners as illustrated in FIG. 2.

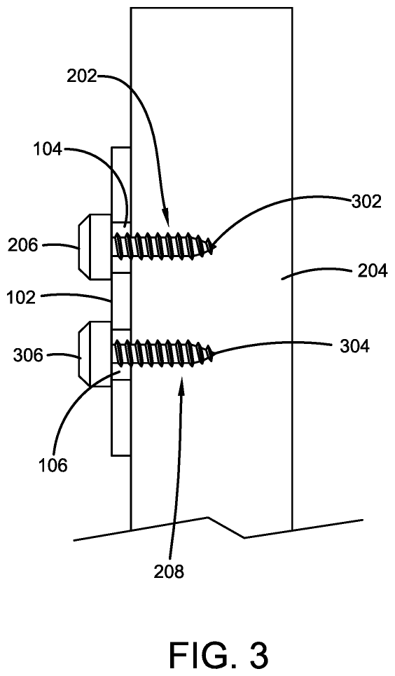

The first member 102 can be made of any lightweight and durable metal or alloy such as iron, aluminium, and steel. The first member 102 has a first groove 104 and a second groove 106 disposed therein. The first groove 104 has curved ends 108, 110 and has a width substantially equal to a diameter of a screw fastener allowing threaded portion of a screw fastener to pass transversely through the first groove 104 as illustrated in FIGS. 2 and 3. Similarly, the second groove 106 has curved ends 112, 114 and has a width substantially equal to a diameter of a screw fastener allowing a threaded portion of a screw fastener to pass transversely through the first groove 104. The fasteners passed across the grooves 104, 106 are used for fastening and securing the door protection device 100 to a door frame.

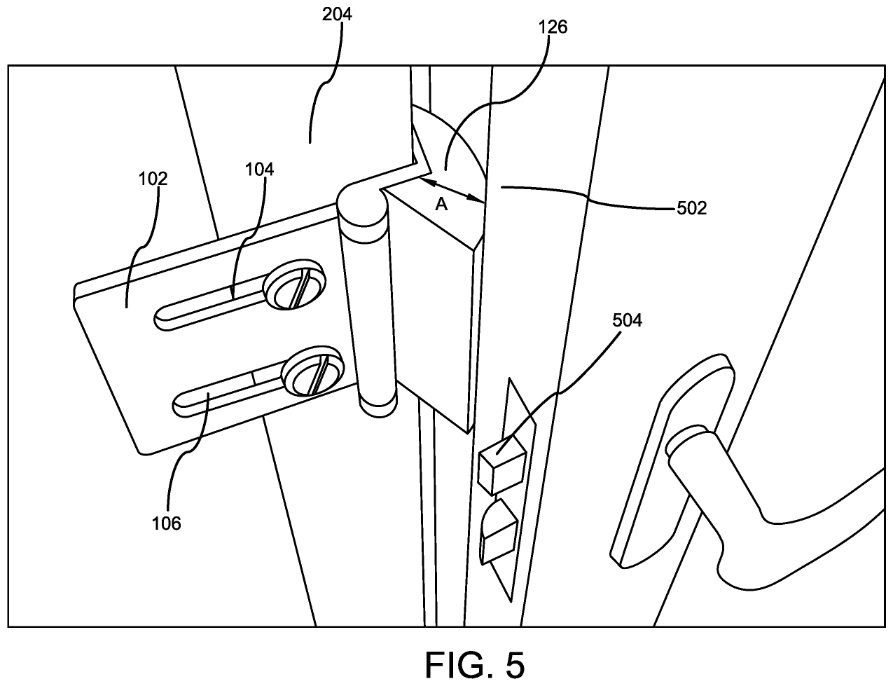

A movable member 116 of the protector device 100 is integrated to the edge 118 of the first member 102 using a hinge 120 that extends across the length of the edge 118. The movable member 116 is configured to move along the hinge 120 relative to the static first member 102. The movable member 116 includes a pair of transverse metal sheets/arms 122, 124 joined together using welding or any other conventional moulding technique. The movable member 116 has an elastomeric device 126 attached to the front surface 128 of the arms 122, 124 for functioning as a shock absorber to cushion the blow of a door as illustrated in FIG. 5.

The elastomeric device 126 can be attached using an adhesive and can be made from one or more Nitrile rubber, Butyl rubber, Neoprene, Chloroprene, Epdm, and more. In different embodiments of the present invention, the rubber can be made of any saturated or unsaturated elastomer.

FIG. 2 illustrates an enlarged view of the door protection device of the present invention fastened to a door frame and oriented for protecting the door, door frame and door lock from damage in accordance with the disclosed structure. Referring to FIGS. 1 and 2, a first fastener 202 is transversely passed through the first groove 104 and is fastened into the door frame 204 using a screw or a drill machine. The curved end 110 supports the threaded portion of the fastener 202 and prevents any slipping or sliding of the first member 102. The head 206 of the first fastener 202 abuts against the first member 102, thereby securing the first member 102 between the first fastener 202 and the door frame 204. Similarly, a second fastener 208 which can be the same or different from the first fastener 202, is also used for securing the first member 102 and is transversely fastened across the second groove 106 into the door frame 204. Depending on the requirements of an individual, additional screw fasteners can be used across one or both the grooves 104, 106 for installing the protection device 100. The device 100 can be installed at any desired position along the frame 204 to prevent physical damage to door frame 204, the door, and associated lock.

Upon installation of the device 100 on the door frame 204, the movable member 116 can pivotally turn along the hinge 120 to position along corner edge 210 of the door frame 204 such that the elastomeric device 126 is positioned between the door and the door frame 204 to protect them from physical damage. The movable member 116 is designed specially to conform and align with the sides 212, 214 of the door frame 204. More specifically, the arm 122 aligns and adheres to the side 212 and the arm 124 aligns and adheres to the side 214.

FIG. 3 illustrates a side perspective view showing the first member 102 of the door protection device of the present invention fastened into the door frame in accordance with the disclosed structure. As illustrated, the plate 102 is fastened to door frame 204 using the screw fasteners 202, 204 passing through the grooves 104, 106 respectively. The threaded portion 302 of the first fastener 202 and threaded portion 304 of the second fastener 208 are screwed and drilled inside the door frame 204 such that the first member 102 securely attached to the door frame 204.

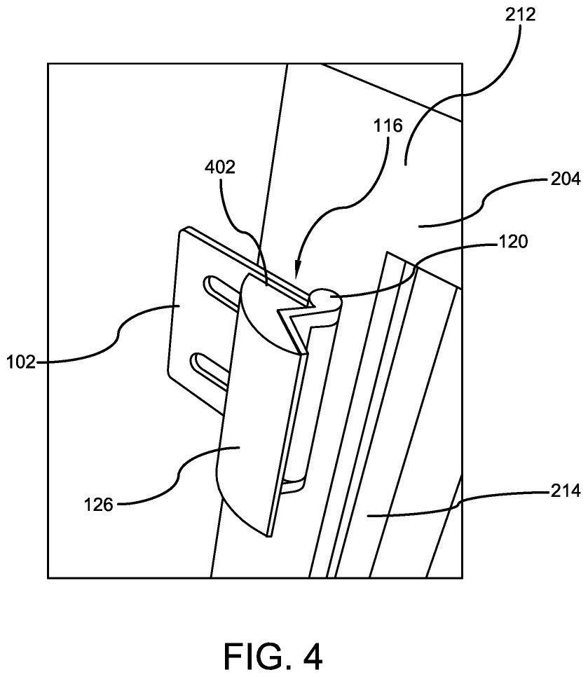

FIG. 4 illustrates a perspective view showing the door protection device installed in the door frame and oriented in a non-operational state in accordance with the disclosed structure. The movable component 116 of the device 100 can be turned towards the first member 102 when the device 100 is not required for absorbing shock from a door. The flat surface 402 of elastomeric device 126 adheres to the first member 102, thus, allowing a door to conventionally close and make contact with the door frame 204. In the non-operational state, the movable component 116 does not align (i.e., arms 122, 124 unaligned) with the sides 212, 214 of the door frame 204.

FIG. 5 illustrates the shock absorber device of the present invention protecting the door while the door is being closed in accordance with the disclosed structure. In operational state, an exterior convex surface of the elastomeric device 126 is exposed to the door 502 and when the door 502 is closed, the door 502 hits the convex surface of the rubber 126 and thus a gap equal to the thickness (shown by arrow A) is maintained between the door frame 204 and the door 502. This also prevents the lock 504 from banging into the door frame 204 and thus protects the lock 504 from physical damage. The rubber 126 absorbs the impact and helps to avoid the damage when the door 502 closes quickly. This also protects fingers of children and other individuals from getting injured due to sudden closing of the door 502.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “shock absorber device”, “door protector device”, “door damage prevention accessory device”, “protection device”, and “device” are interchangeable and refer to the door damage prevention accessory device 100 of the present invention.

Notwithstanding the forgoing, the door damage prevention accessory device 100 of the present invention can be of any suitable size and configuration as is known in the art without affecting the overall concept of the invention, provided that it accomplishes the above stated objectives. One of ordinary skill in the art will appreciate that the door damage prevention accessory device 100 as shown in the FIGS. 1-5 are for illustrative purposes only, and that many other sizes and shapes of the door damage prevention accessory device 100 are well within the scope of the present disclosure. Although the dimensions of the door damage prevention accessory device 100 are important design parameters for user convenience, the door damage prevention accessory device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A door and door frame protector device comprising:
a door protection device having a static mounting member and a movable member, wherein said mounting member mounted on a door frame with at least a pair of fasteners;
wherein said mounting member having a first groove cut-out and a second groove cut-out;
wherein said first groove cut-out having a width substantially equal to a diameter of a first fastener and said second groove cut-out having a width substantially equal to a diameter of a second fastener;
wherein said movable member hingedly connected to a terminal edge of said mounting member;
wherein said terminal edge having a rotatable hinge for rotating said movable member relative to said mounting member;
wherein said movable member having a pair of transverse arms including an elastomeric device attached to front surfaces of said pair of transverse arms;
wherein said movable member rotates from a non-operational position to an operational position upon closing the door in the door frame; and
further wherein said elastomeric device provides a compressible cushion between a portion of the door and a portion of the door frame.

2. The door frame protector device of claim 1, wherein said elastomeric device having a material selected from a group consisting of one or more of a Nitrile rubber, a Butyl rubber, a Neoprene, a Chloroprene, and a Epdm.

3. The door frame protector device of claim 1, wherein said first groove cut-out having a first length and said second groove cut-out having a second length, further wherein said first length is equal to said second length.

4. The door frame protector device of claim 3, wherein said first groove cut-out slidingly movable around said first fastener and said second groove cut-out slidingly movable around said second fastener for selectively positioning said movable member toward and away from the door.

5. The door frame protector device of claim 4, wherein said mounting member selectively mountable along any portion of a length of the door frame.

6. The door frame protector device of claim 5, wherein said mounting member is rectilinear.

7. The door frame protector device of claim 6, wherein said mounting member having a material selected from a group consisting of a metal, an iron, an aluminium, and a steel.

8. The door frame protector device of claim 1, wherein a first arm of said pair of transverse arms aligns with a first side of the door frame and a second arm of said pair of transverse arms aligns with a second side the door frame upon closing the door in the door frame.

9. The door frame protector device of claim 8, wherein said first arm and said second arm are orthogonal to each other.

10. The door frame protector device of claim 9, wherein said elastomeric device having a convex outer surface.

11. A door and door frame protector device comprising:
a door protection device having a static mounting member and a movable member, wherein said mounting member mounted on a door frame with at least a pair of fasteners;
wherein said mounting member having a first groove cut-out and a second groove cut-out;
wherein said first groove cut-out having a width substantially equal to a diameter of a first fastener and said second groove cut-out having a width substantially equal to a diameter of a second fastener;
wherein said movable member hingedly connected to a terminal edge of said mounting member;
wherein said terminal edge having a rotatable hinge for rotating said movable member relative to said mounting member;
wherein said movable member having a pair of transverse arms including an elastomeric device attached to front surfaces of said pair of transverse arms;
wherein said elastomeric device having a convex outer surface;
wherein said movable member rotates from a non-operational position to an operational position when the door contacts said convex outer surface of said elastomeric device and upon closing the door in the door frame; and
further wherein said elastomeric device provides a compressible cushion between a portion of the door and a portion of the door frame.

12. The door frame protector device of claim 11, wherein said elastomeric device having a material selected from a group consisting of one or more of a Nitrile rubber, a Butyl rubber, a Neoprene, a Chloroprene, and a Epdm.

13. The door frame protector device of claim 11, wherein said first groove cut-out having a first length and said second groove cut-out having a second length, further wherein said first length is equal to said second length.

14. The door frame protector device of claim 13, wherein said first groove cut-out slidingly movable around said first fastener and said second groove cut-out slidingly movable around said second fastener for selectively positioning said movable member toward and away from the door.

15. The door frame protector device of claim 11, wherein said mounting member selectively mountable along any portion of a length of the door frame.

16. The door frame protector device of claim 15, wherein said mounting member having a material selected from a group consisting of a metal, an iron, an aluminium, and a steel.

17. The door frame protector device of claim 11, wherein a first arm of said pair of transverse arms aligns with a first side of the door frame and a second arm of said pair of transverse arms aligns with a second side the door frame upon closing the door in the door frame.

18. The door frame protector device of claim 17, wherein said first arm and said second arm are orthogonal to each other.

19. A door and door frame protector device comprising:
a door protection device having a static mounting member and a movable member, wherein said mounting member mounted on a door frame with at least a pair of fasteners;
wherein said mounting member having a first groove cut-out and a second groove cut-out;
wherein said first groove cut-out having a width substantially equal to a diameter of a first fastener and said second groove cut-out having a width substantially equal to a diameter of a second fastener;
wherein said movable member hingedly connected to a terminal edge of said mounting member;
wherein said terminal edge having a rotatable hinge for rotating said movable member relative to said mounting member;
wherein said movable member having a pair of transverse arms including an elastomeric device attached to front surfaces of said pair of transverse arms;
wherein said elastomeric device having a convex outer surface;
wherein said movable member rotates from a non-operational position to an operational position when the door contacts said convex outer surface of said elastomeric device and upon closing the door in the door frame;
wherein a first arm of said pair of transverse arms aligned with a first side of the door frame and a second arm of said pair of transverse arms aligned with a second side the door frame when said movable member is in said operational position;
wherein said first arm unaligned with the first side of the door frame and said second arm unaligned with the second side the door frame when said movable member is in a non-operational position; and
further wherein said elastomeric device provides a compressible cushion between a portion of the door and a portion of the door frame.

20. The door frame protector device of claim 19, wherein said mounting member selectively mountable along any portion of a length of the door frame.
